(19) United States
(12) Patent Application Publication
(10) Pub. No.: US 2014/0116590 A1
(43) Pub. Date: May 1, 2014

(54) Heavy Duty Tire

(71) Applicant: The Goodyear Tire & Rubber Company, Akron, OH (US)

(72) Inventors: Max Harold Dixon, Kent, OH (US); Robert Anthony Neubauer, Medina, OH (US)

(73) Assignee: The Goodyear Tire & Rubber Company, Akron, OH (US)

(21) Appl. No.: 13/661,234

(22) Filed: Oct. 26, 2012

(51) Int. Cl. B60C 11/11

(52) U.S. Cl. CPC B60C 11/11
USPC 152/209.22; 152/209.1

(57) ABSTRACT

An off the road tire comprising a carcass, a tread located radially outward of the carcass, the tread having a plurality of lugs, the lugs extending radially outward from an inner tread and being located between first and second lateral tread edges, a first row of lugs extending from the tread lateral edge axially inwards toward the centerplane, a second row of lugs extending from the opposite tread lateral edge and axially inwards toward the centerplane and wherein the lugs of the first and second rows are separated by a plurality of shoulder grooves, a third row of lugs located between the first and second row of lugs, wherein all of the lugs in each row are aligned circumferentially, wherein the lugs in the third row have two or more ends formed by nonlinear grooves.

### FIELD OF THE INVENTION

The present invention relates to pneumatic tires, and more particularly to very large, wide base tires for use for example, on construction vehicles such as earth movers, and rigid haul dump trucks.

### BACKGROUND OF THE INVENTION

In very large tires having a diameter of 80 inches or more, tire operating conditions can be severe because of the extreme tire loading and off-road conditions. Furthermore, the speed of the vehicles may be high, which can result in excessive heat build up in the tire. Thus it is desired to have an improved tire which is a cooler running tire.

### Definitions

“Aspect Ratio” means the ratio of a tire's section height to its section width.

“Axial” and “axially” means the lines or directions that are parallel to the axis of rotation of the tire.

Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 7° to 36° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“net to gross ratio” means the ratio of the area of the tread in the footprint that contacts the road to the total area of the tread in the footprint.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a perspective view of a tire of the present invention;

FIG. 2 is a front view of the tire of the present invention;

FIG. 3 is a side view of the tire of the present invention;

FIG. 4 is a close up front view of the tire footprint;

FIG. 5 is a partial cross sectional view of groove 57.

FIG. 6 is a partial cross sectional view of groove 45.

FIG. 7 is a cross-sectional view of groove 55.

FIG. 8 is a cross-sectional view of centerline channel groove.

### DETAILED DESCRIPTION OF THE INVENTION

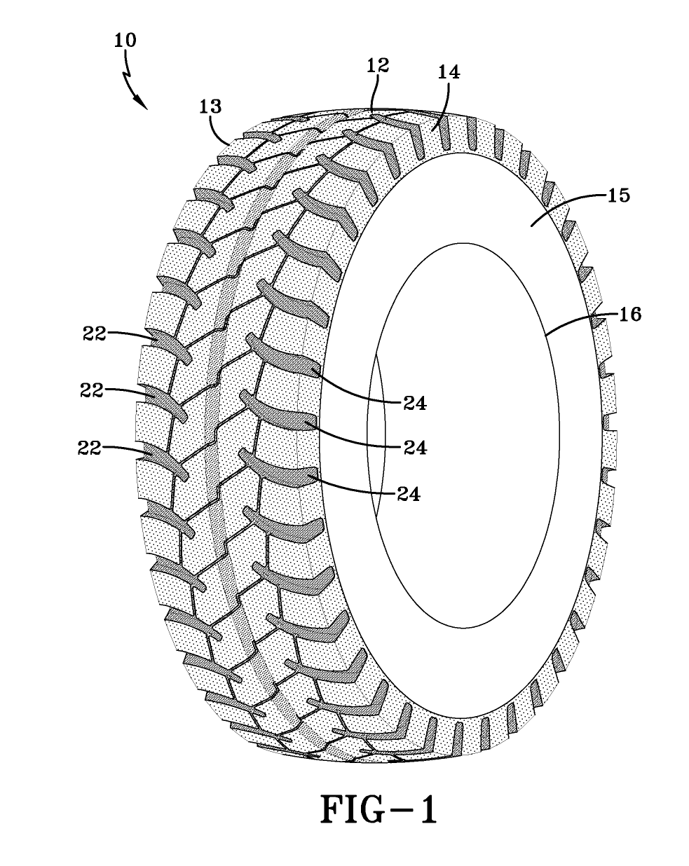

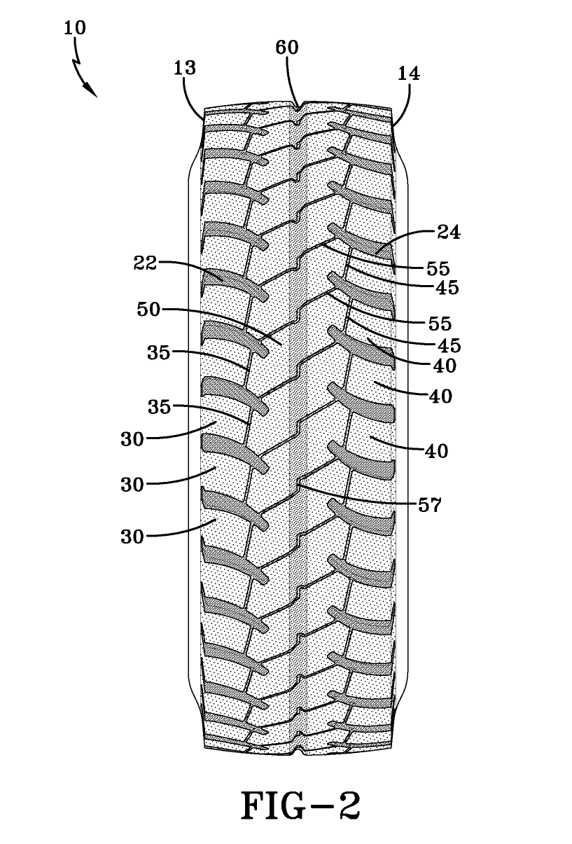

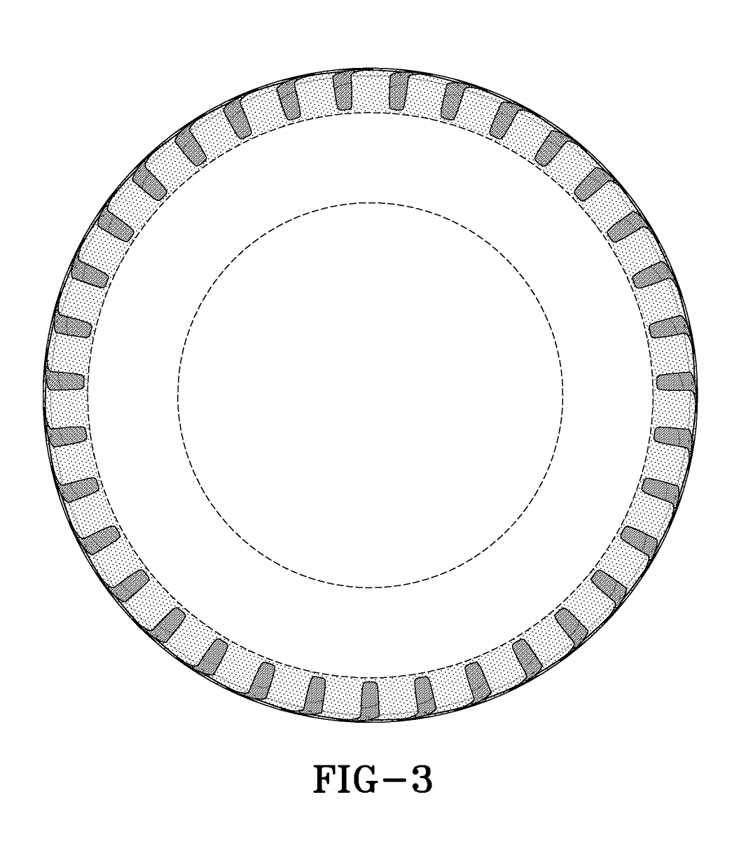

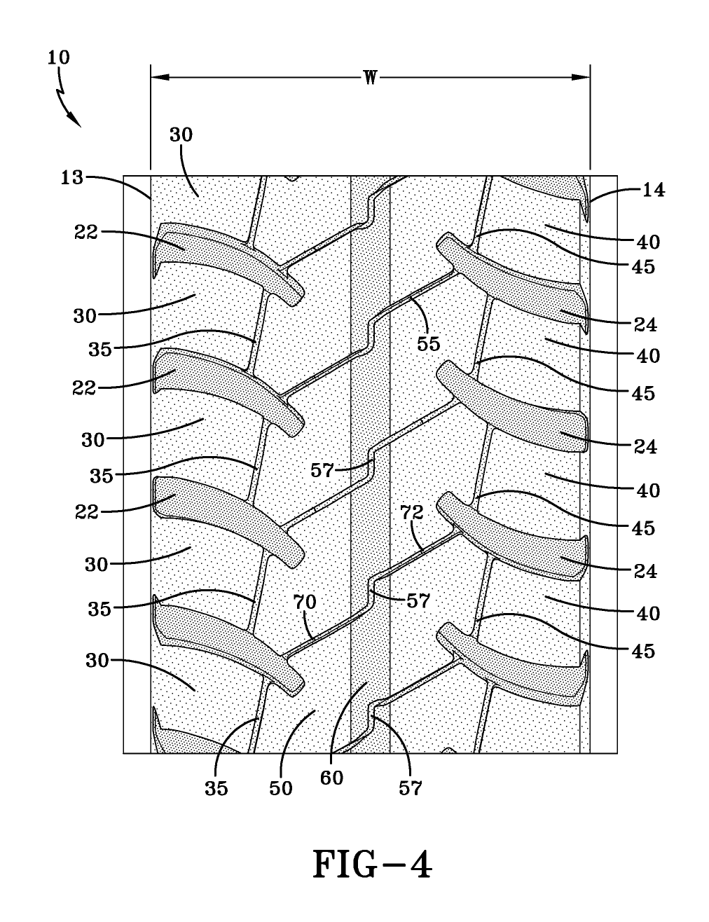

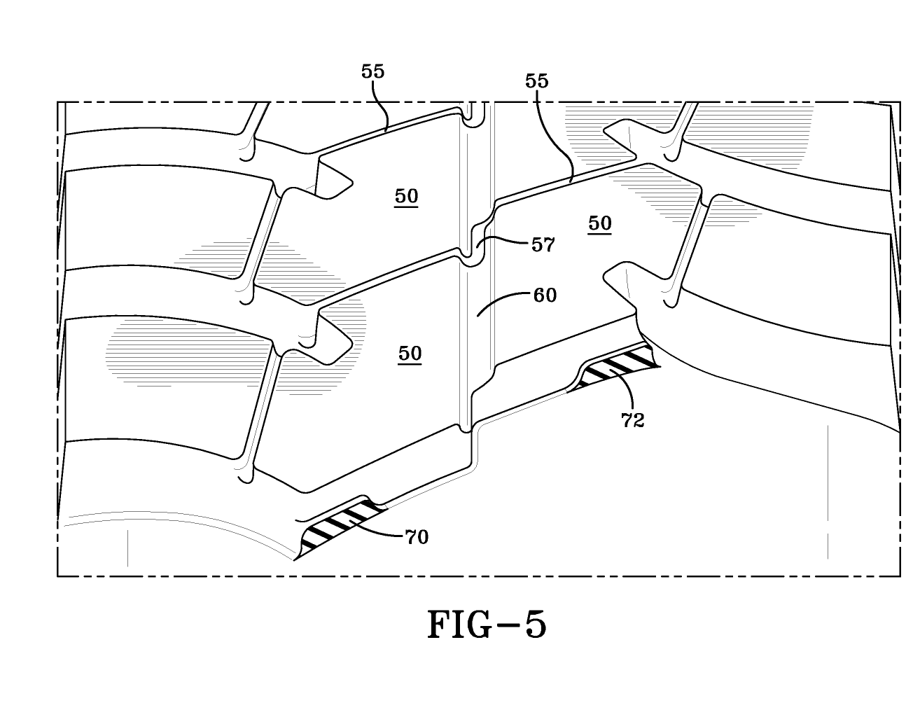

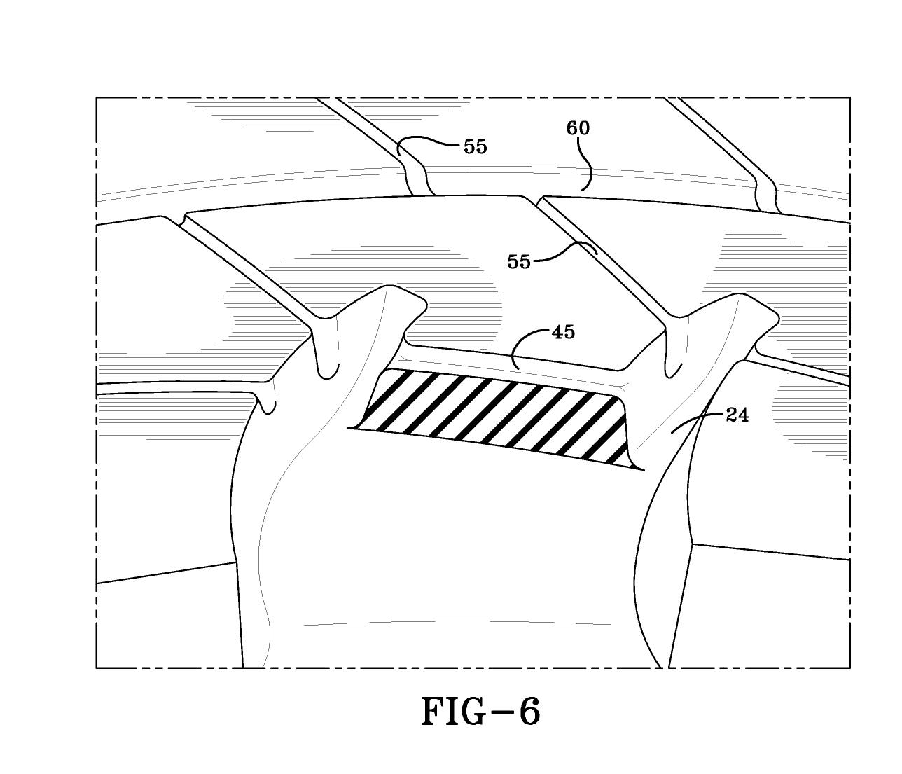

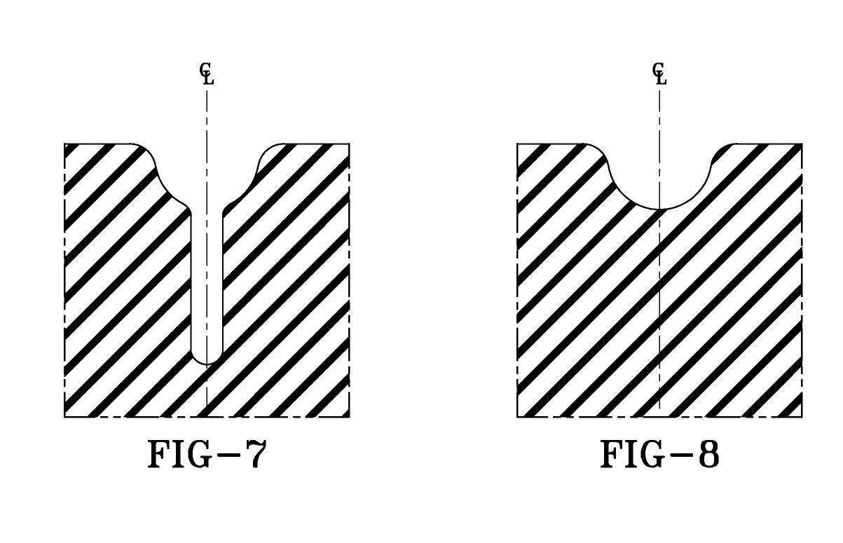

FIGS. 1-4 illustrate a first embodiment of a tire 10 of the present invention. The tire may have a nominal rim diameter of 35 inches or more. The tire 10 has an outer ground engaging tread portion 12 which has axially outer lateral edges 13, 14. Sidewalls 15 extend radially inward from the tread lateral edges 13,14 and terminate in a pair of bead regions 16 having an annular bead core (not shown). The tire 10 is further provided with a carcass which has a reinforcing ply structure (not shown) which extends from bead region to bead region. The tire may further include breakers and other tire components known to those skilled in the art.

The tire tread 12 preferably has a non-directional tread pattern. The tread 12 comprises two rows of shoulder grooves 22,24 wherein each row of shoulder grooves extend from a respective lateral tread edge 13,14 towards the centerplane of the tread. The shoulder grooves 22,24 do not cross the centerline of the tread and are angled at an angle θ1, θ2. The shoulder grooves in the first row 22 are circumferentially offset or staggered from the shoulder grooves in the second row 24. The shoulder grooves in the first row 22 are similarly shaped as the shoulder grooves in the second row, and have an angular orientation that is rotated about 180 degrees out of phase from the other row. The shoulder grooves are deep, and have a depth of 70-100% of the non skid tread depth, or NSK, and more preferably 90-100% of the NSK. The shoulder grooves 22,24 are angled at an angle θ1, θ2 in the range of about 20-45 degrees, more preferably in the range of about 30 to 45 degrees. The high angled grooves provide forward and lateral traction. The width of the shoulder grooves are about 25-40% of the tread width W, and more preferably 30-38% of the tread width W.

The tread is further divided into three rows of lugs. A first row of lugs is comprised of circumferentially aligned lugs 30 which extend from the lateral tread edge 13 to a cross groove 35. Each lug in row 30 is further bounded by two shoulder grooves 22, and have the same angular orientation as the shoulder grooves 22. Each lug has a width of about ⅔ the width of the shoulder grooves 22. The cross grooves 35 are circumferentially aligned and extend in a circumferential direction completely across the lugs 30 joining the shoulder grooves 22. The cross groove 35 is a shallow groove whose depth varies from about 10% to about 20% NSK, more preferably about 15% NSK. The cross groove 35 has a width of about 10% to about 20% of the width of the shoulder grooves 22. The cross grooves 35 form a small angle of about 10-15 degrees with the circumferential direction.

The tread further comprises a second circumferentially aligned row of lugs 40. The second row is comprised of lugs 40 which extend from the opposite lateral tread edge 14 and axially inward to a second row of cross grooves 45. Each lug 40 is further bounded by two shoulder grooves 24, and have the same angular orientation as the shoulder grooves. Each lug has a width of about ⅔ the width of the shoulder grooves 24. The cross grooves 45 are circumferentially aligned and extends in a circumferential direction completely across the lug 40 joining the adjacent shoulder grooves 24. The cross groove 45 depth varies from about 10% to about 20% NSK, more preferably about 15% NSK. The second groove has a width of about 10% to about 20% of the width of the shoulder grooves.

The tread further comprises a third circumferentially spaced row of center lugs 50. The center lugs 50 may or not be the same size. The axially outer ends of lugs are defined by cross grooves 35, 45 which are parallel to each other. The border of lugs 50 are further defined by nonlinear grooves 55 which are circumferentially aligned and in parallel relation with each other. The border of lugs 50 are further defined by the shoulder grooves which extend into the area defined by grooves 35,45, and 55, resulting in an irregular shape of lugs 50. Nonlinear grooves 55 are preferably zigzag shaped which results in an interlocking feature. Grooves 55 preferably have a circumferential aligned portion 57 which is preferably located in the centerline of the tread. The nonlinear grooves 55 are deep, and have a depth in the range of about 50% to about 90% of the NSK, or more preferably in the range of about 60-90% NSK. The width of the nonlinear grooves 55 are in the range of about 10-15% of the width of the shoulder grooves. The nonlinear grooves may further comprise tie bars 70,72 located at the opposed ends of the groove, near the shoulder grooves. The tie bars help stiffen the center tread region. The tire bars have a height about 50% of the NSK.

An optional centerline groove 60 may be oriented on the centerline of the tread. Grooves 55 may also be angled in the range of 30 to 45 degrees from the axial direction. Grooves 35, 45, 55, and 60 together with the grooves 22, 24 function to provide a cooling path of air around the lugs 30,40,50 to cool the lugs. The Grooves are spaced to maximize the cooling surface area around the lugs so that at any point on the surface of the lug, the distance from the point to a groove is minimized.

The overall net to gross ratio of the tire ranges from about 60 to about 80, more preferably about 65 to 75, and most preferably in the range of about 68 to 72.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An off the road tire comprising a carcass, a tread located radially outward of the carcass, the tread having a plurality of lugs, the lugs extending radially outward from an inner tread and being located between first and second lateral tread edges, a first row of lugs extending from the tread lateral edge axially inwards toward the centerplane, a second row of lugs extending from the opposite tread lateral edge and axially inwards toward the centerplane and wherein the lugs of the first and second rows are separated by a plurality of shoulder grooves, a third row of lugs located between the first and second row of lugs, wherein all of the lugs in each row are aligned circumferentially, wherein the lugs in the third row have two ends formed by nonlinear grooves, wherein the nonlinear grooves each have at least one tie bar.

2. The tire of claim 1 wherein the lugs of the third row have lateral ends formed by parallel grooves.

3. The tire of claim 1 wherein the lugs of the third row have a radially inner end and a radially outer end formed by the nonlinear grooves which are parallel to each other.

4. The tire of claim 1 wherein the lugs of the third row are intersected by shoulder grooves.

5. The tire of claim 1 wherein the nonlinear grooves have a circumferential portion which extends in the circumferential direction.

6. The tire of claim 1 wherein the nonlinear grooves are Z shaped.

7. The tire of claim 1 wherein the nonlinear grooves are S shaped.

8. The tire of claim 5 wherein the circumferential portion is located on the tire centerline.

9. The tire of claim 1 wherein the tread further comprises a centerline groove.

10. The tire of claim 1 wherein the nonlinear groove extends from one shoulder groove to another shoulder groove.

11. The tire of claim 1 wherein the nonlinear groove is angled in the range of about 40 to about 75 degrees with respect to axial direction.

12. The tire of claim 1 wherein the tread does not have circumferentially continuous grooves which connect to the shoulder grooves.

13. The tire of claim 1 wherein the first row and second row of lugs are each bounded by the shoulder grooves and a cross groove.

14. The tire of claim 1 wherein the shoulder grooves have a depth in the range of 80-100% NSK.

15. The tire of claim 1 wherein the shoulder grooves have a depth in the range of 90-100% NSK.

16. The tire of claim 1 wherein the nonlinear grooves have a depth in the range of 75-100% NSK.

17. The tire of claim 1 wherein the shoulder lugs are not axially wider than the shoulder grooves.

18. An off the road tire comprising a carcass, a tread located radially outward of the carcass, the tread having a first and second row of circumferentially aligned shoulder lugs, wherein the first and second row of shoulder lugs are separated by a plurality of shoulder grooves; said tread further comprising a center row of lugs, wherein the center row of lugs are bounded by two sets of parallel grooves, wherein the first set of parallel grooves intersect with the second set of parallel grooves and defining a center lug area, except that a portion of at least two shoulder grooves extends into the center lug area.

19. The tire of claim 17 wherein the center lug area is intersected by a shoulder groove at each corner formed between the first and second set of parallel grooves.

20. The tire of claim 17 wherein the first set of parallel grooves are nonlinear.

21. The tire of claim 17 wherein the first set of parallel grooves extend from a first shoulder groove in a first row to a second shoulder groove in a second row.

22. The tire of claim 17 wherein the first set of parallel grooves have one or more tie bars.

23. The tire of claim 17 wherein the first set of parallel grooves have at least one tie bar on a lateral end.

24. The tire of claim 17 wherein the second set of parallel grooves extend between adjacent shoulder grooves in the same row.
